(19) United States
(12) Patent Application Publication
(10) Pub. No.: US 2010/0106579 A1
(43) Pub. Date: Apr. 29, 2010

(54) SYSTEM AND METHOD FOR DETERMINING CONSUMER INCENTIVES BASED UPON POSITIVE CONSUMER BEHAVIOR

(75) Inventors: Christine C. Etheredge, New York, NY (US); Jessica A. Kaplan, New York, NY (US); Deepak K. Kapoor, Hartsdale, NY (US); Jason K. Leung, Jersey City, NJ (US); Denee Perry, Brooklyn, NY (US); Larry Sharnak, Brunswick, NJ (US); E. Bai Koo, New York, NY (US)

Correspondence Address: Snell & Wilmer L.L.P. (AMEX), ONE ARIZONA CENTER, 400 E. VAN BUREN STREET, PHOENIX, AZ, 85004-2202, US

(73) Assignee: American Express Travel Related Services Company, Inc., New York, NY (US)

(21) Appl. No.: 12/546,448

(22) Filed: Aug. 24, 2009

Related U.S. Application Data
(63) Continuation-in-part of application No. 12/496,394, filed on Jul. 1, 2009.
Application No. 12/496,394 is a continuation-in-part of application No. 11/850,821, filed on Sep. 6, 2007.
(60) Provisional application No. 60/912,314, filed on Apr. 17, 2007.

(51) Int. Cl. G06Q 30/00; G06Q 40/00

(52) U.S. Cl. 705/14.17; 705/14.25

(57) ABSTRACT

The system evaluates a set of incentives based upon a variety of factors and/or predetermined rules and consumers are provided incentives when they satisfy one or more criteria of making payments for their transaction accounts. The one or more criteria include making an early payment, paying more than a minimum amount due, and making the payment through an automatic payment scheme. If a received payment satisfies one or more predefined criteria, one or more incentives are selected for the consumer, tracked, and provided to the consumer. The system analyzes payment information to determine attributes and positive (desirable) behavior and provides incentives to the consumer based on such positive behaviors.

### CROSS REFERENCE TO RELATED APPLICATIONS

This application is a continuation-in-part, and claims priority to U.S. application Ser. No. 12/496,394 entitled “System and Method for Incentivizing Consumers” and filed Jul. 1, 2009. The '394 application is a continuation-in-part, and claims priority to U.S. application Ser. No. 11/850,821, entitled “System and Method for Flexible Payment Terms” filed on Sep. 6, 2007. The '821 application claims priority to, and the benefit of, U.S. Provisional Application Ser. No. 60/912,314, entitled “System and Method for Flexible Payment Terms” and filed Apr. 17, 2007. All of the above-listed applications are incorporated herein by reference.

### FIELD OF INVENTION

The present invention generally relates to providing incentives to consumers, and more particularly, to providing incentives to consumers for demonstrating desirable behaviors.

### BACKGROUND OF THE INVENTION

Various programs have been established to enable consumers and businesses to conveniently and timely facilitate purchases based on a line of credit. Consumers may enjoy some tangible value from utilizing a cash-back account, or an interest-free revolving credit account. However, such accounts often include only one feature and/or the interest-free benefit is limited to a small term, namely only 12-15 months of no interest. In contrast, recent research has demonstrated that choice and flexibility provide a much greater tangible value for a segment of small business consumers, and a value that is not being provided today by transaction account companies.

Indeed, consumers of transaction accounts constantly desire greater choice and flexibility. Particularly, many consumers are capable of paying back their transaction account bills for larger amounts than the minimum expectation of the transaction account company. Further, many consumers can pay their transaction account bills sooner than the due date set by the transaction account company. Transaction account companies usually consider such consumers desirable from various perspectives, such as risk management, cash flow management, and the like. Yet, most transaction account companies do little to deliver greater value to such consumers.

Improved cash flow management is a core need of any consumer or small business. There are many financial tools that exist to help small businesses and consumers with cash flow management (e.g. lines of credit, promotional periods on credit accounts, loans etc.). However, none of these products sufficiently combine these features on a transaction account in a manner which provides ease of accessibility and broad scale reach. As such, a long felt need exists for a consumer incentive and line of credit product that combines the features of existing financial tools to provide greater value and payment flexibility.

### SUMMARY OF THE INVENTION

Methods and systems provide consumers with various incentives designed to influence the consumer's behavior. In general, the system may evaluate consumer information and determine one or more incentives to offer the customer in order to influence the customer behavior. The incentive may comprise eligibility requirements, acceptance terms and conditions, a desired attribute that is used to determine when a consumer exhibits a desired behavior and/or a reward for exhibiting the desired behavior.

In one embodiment, the methods and systems provide a transaction account issuer with the ability to prospectively adjust interest rates to account for risk. As part of their risk adjustment strategy, the transaction account issuer may offer incentives to customers in order to influence the customer to exhibit “good behavior” (e.g., behavior that lowers the transaction account issuer's risk exposure with respect to that customer). In one embodiment, a transaction account issuer system receives a payment and determines payment information associated with the payment. The payment information is interpreted to determine whether criteria that correspond to “good behavior” has been partially or fully satisfied and, based at least partially upon this determination, the transaction account issuer may choose one or more incentives to offer the customer (e.g., the customer may be offered a lower annual percentage rate (APR)). In one embodiment, incentives are pre-defined. The system may evaluate payment information, interpret or infer good behavior and formulate incentives based upon the good behavior and other factors. The system may offer incentives to a customer (or set of customers) prior to receiving an indication of good behavior, and then match subsequent customer behavior to the terms of the incentive offer.

By offering such incentives (and/or providing rewards linked to the incentives), transaction account issuing companies may encourage more consumers to shift from ordinary payment behavior to desirable payment behavior. Also, the transaction account issuing companies may be able to differentiate between consumers on the basis of the default risk they pose, where a consumer exhibiting desirable payment behavior is less likely to default than a consumer exhibiting ordinary payment behavior. With the help of this differentiation, the transaction account issuing companies may offer better incentives to low risk consumers, thereby providing additional value to these consumers and creating stronger consumer loyalty. In addition, the transaction account issuing companies are able to attract low risk profile consumers.

In one embodiment, the system obtains consumer information associated with a consumer, where the consumer is associated with a first transaction account. The system determines, based at least partially upon the consumer information, a desired positive behavior of the consumer and determines a first incentive associated with the desired positive behavior. The system determines, based at least partially upon the desired positive behavior, that the consumer is eligible to receive the first incentive and produces output, based at least partially upon the first incentive, in order to offer the consumer the first incentive.

### BRIEF DESCRIPTION OF THE DRAWINGS

A more complete understanding of the present inventions may be derived by referring to the detailed description and claims when considered in connection with the Figures, wherein like reference numbers refer to similar elements throughout the Figures, and:

FIG. 1 is a block diagram illustrating major system components for accepting and processing payment term options, in accordance with an exemplary embodiment of the present invention;

FIGS. 2A-2B are flow charts illustrating an exemplary process for end of cycle processing of early and deferred payments, in accordance with an exemplary embodiment of the present invention;

FIG. 3 is flow chart illustrating an exemplary posting process relating to a deferred payment term option, in accordance with an exemplary embodiment of the present invention;

FIG. 4 is a flow chart illustrating an exemplary process for incentivizing consumers, in accordance with an exemplary embodiment of the present invention; and

FIG. 5 is a flow chart illustrating an exemplary process for incentivizing consumers, in accordance with another exemplary embodiment of the present invention.

### DETAILED DESCRIPTION

The detailed description herein is presented for purposes of illustration only and not of limitation. For example, the steps recited in any of the method or process descriptions may be executed in any order and are not limited to the order presented. For the sake of brevity, conventional data networking, application development and other functional aspects of the systems (and components of the individual operating components of the systems) may not be described in detail herein.

The systems and methods include a unique combination of one or more features associated with a transaction account. In one embodiment, the system allows the flexibility to choose certain optional payment terms each month or during any other pre-defined, random, periodic or other time period. The consumer, host, issuer, acquirer, merchant and/or any other entity may be able to choose the payment term. In one embodiment, the payment terms include an early payment discount, a deferred payment term with a deferral fee (without an interest charge) and a standard payment term. The system further incentivizes consumers when the consumers satisfy one or more “good behavior” criteria during payment. In one embodiment, the one or more criteria may include making an early payment, paying more than a minimum amount due, and making the payment via an automatic payment scheme.

“Entity” may include any individual, consumer, consumer, group, business, organization, government entity, transaction account issuer or processor (e.g., credit, charge, etc), merchant, consortium of merchants, consumer, account holder, charitable organization, software, hardware, and/or any other entity.

An “account”, “account number” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account. The system may include or interface with any of the foregoing accounts or devices, or a transponder and RFID reader in RF communication with the transponder (which may include a fob). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

A “transaction account” may include any account that may be used to facilitate a financial transaction.

A “financial institution” or “transaction account issuer” includes any entity that offers transaction account services to consumers. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

A “financial processor,” “payment network,” or “payment system” or may include any entity which processes transactions, issues accounts, acquires financial information, settles accounts, conducts dispute resolution regarding accounts, and/or the like. As one of ordinary skill will recognize a financial account issuer may operate as, and provide the functions and services of a financial processor.

A “merchant” may include any entity that receives payment or other consideration. For example, a merchant may request payment for services rendered from a consumer who holds an account with a transaction account issuer.

An “item” may include any good or service. For example, a merchant may sell an item to a consumer and the consumer may provide payment for the item using a transaction account (e.g. a credit card).

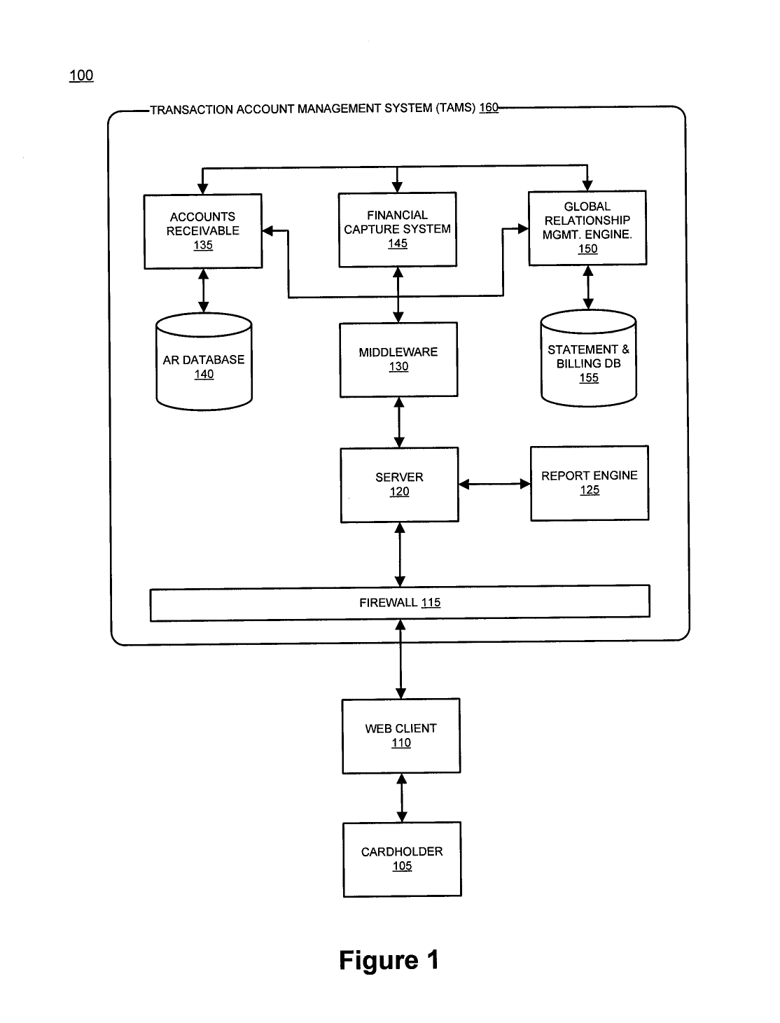

With reference to FIG. 1, system 100 facilitates interaction between a consumer 105 and a Transaction Account Management System (TAMS) 160 through, in one embodiment, a web client 110 with a network connection to an Internet server 120 by way of the Internet. In one embodiment, Internet server 120 employs an authentication server to validate credentials, assign proper permissions, and retrieve preferences information for authorized consumers of TAMS 160. In an embodiment, Internet server 120 employs an application server to manage various applications and utilities that are utilized by system 100. In various embodiments, Internet server 120 interacts directly with the various systems and components disclosed herein. System 100 may include any number of computing platforms and databases that may be commonly found within a typical transaction account environment (e.g., at a payment processor, account issuer system, payment network, transactions database etc.).

Such systems may include, for example, an accounts receivable system 135, an accounts receivable (AR) database 140, a financial capture system 145, a global relationship management engine 150, and a statement and billing database 155. Other systems may include, for example, new accounts systems, management information systems, business information systems, third-party data providers and the like. Each of the systems may be interconnected within by a network in via any method and/or device described herein.

A middleware server and/or application 130 may serve as an intermediary between the various systems to ensure appropriate communications between disparate platforms. A report engine 125 retrieves and/or is provided with data from the various systems in order to generate billing statements, reports, and the like.

TAMS 160 or any other components discussed herein may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more of the components of system 100 may be embodied as a customization of an existing system, an add-on product, upgraded software, a stand alone system (e.g., kiosk), a distributed system, a method, a data processing system, a device for data processing, a computer and/or a computer program product. Accordingly, individual system 100 components may take the form of an entirely software embodiment, an entirely hardware embodiment, or an embodiment combining aspects of both software and hardware. In one embodiment, a system 100 component (e.g. a computer) may include a processor, a memory, a communications interface, a network interface, etc. Furthermore, individual system 100 components may take the form of a computer program product on a computer-readable storage medium having computer-readable program code means embodied in the storage medium. Any suitable computer-readable storage medium may be utilized, including hard disks, CD-ROM, flash memory, optical storage devices, magnetic storage devices, and/or the like. In one embodiment, a system 100 component and/or subsystem comprises a network interface communicating with a memory, the memory communicating with a processor; and the processor, when executing a computer program, configured to accomplish a variety of functions and/or steps.

The system contemplates uses in association with web services, utility computing, pervasive and individualized computing, security and identity solutions, autonomic computing, commodity computing, mobility and wireless solutions, open source, biometrics, grid computing and/or mesh computing.

Consumer 105 may include any entity that utilizes system 100. Consumer 105 may also include any entity that has a transaction account with a transaction account issuer. For example, Consumer 105 may also include anyone who applied for the account, currently has the card in her possession, has proxy or other rights to use or maintain the account, is partially or fully responsible to pay the charges on the account and/or the like. Consumer 105 may include a consumer who uses an account code without any physical card, uses a transponder, and/or uses a physical transaction card, to purchase items which are billed on the billing statement discussed herein. Consumer 105 may also select payment terms relating to a revolving line of credit account, submit payments, and/or view billing statements. Consumer 105 may be, for example, an American Express® card member who elects a payment term. In an embodiment, consumer 105 may be, for example, an American Express® card member who receives incentives for satisfying one or more criteria during payments. In one embodiment, consumer 105 may be a consumer service representative or the like who interacts with system 100 to provide account information and configure payment terms or terms on behalf of a transaction account holder. In various embodiments, consumer 105 may interface with TAMS 160 via any communication protocol, device or method discussed herein or known in the art. For example, consumer 105 may interact with TAMS 160 by way of an Internet browser at web client 110.

Web client 110 comprises any hardware and/or software suitably configured to facilitate requesting, retrieving, updating, analyzing, entering and/or modifying data. For example, in one embodiment, web client 110 is configured to facilitate input, receipt and/or review of information relating to merchants that are selected based on a search term entered into a search engine such as, for example, Google™, Yahoo™, MSN™, AOL™, and/or any other Internet-wide or web site centric search engines. Web client 110 includes any device (e.g., personal computer) which communicates (in any manner discussed herein) with TAMS 160 via any network discussed herein. Such browser applications comprise Internet browsing software installed within a computing unit or system to conduct online transactions and/or communications. These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. Practitioners will appreciate that web client 110 may or may not be in direct contact with TAMS 160. For example, web client 110 may access the services of TAMS 160 through another server, which may have a direct or indirect connection to Internet server 120.

As those skilled in the art will appreciate, web client 110 includes an operating system (e.g., Windows NT, 95/98/2000, OS2, UNIX, Linux, Solaris, MacOS, etc.) as well as various conventional support software and drivers typically associated with computers. Web client 110 may include any suitable personal computer, network computer, workstation, minicomputer, mainframe or the like. Web client 110 can be in a home or business environment with access to a network. In an exemplary embodiment, access is through a network or the Internet through a commercially available web-browser software package.

Web client 110 may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network.

Web client 110 may include any number of applications, code modules, cookies, and the like to facilitate interaction with TAMS 160 in order to, for example, view statements, view payment terms, view spend information, elect a payment term, submit/authorize a payment, and the like. In one embodiment, web client 110 may store consumer 105 preferences and/or any other information disclosed herein on a hard drive or any other local memory device. Accordingly, web client 110 may retrieve and store consumer information within a memory structure of web client 110 in the form of a browser cookie, for example. In another embodiment, web client 110 retrieves information relating to consumer 105 from TAMS 160 on establishing a session with Internet server 120.

Firewall 115, as used herein, may comprise any hardware and/or software suitably configured to protect TAMS 160 components from users of other networks. Firewall 115 may reside in varying configurations including stateful inspection, proxy based and packet filtering among others. Firewall 115 may be integrated as software within Internet server 120, any other TAMS 160 components or may reside within another computing device or may take the form of a standalone hardware component.

Internet server 120 may include any hardware and/or software suitably configured to facilitate communications between web client 110 and one or more TAMS 160 components. Further, Internet server 120 may be configured to transmit data to web client 110 within markup language documents. As used herein, “data” may include encompassing information such as commands, queries, files, data for storage, and/or the like in digital or any other form. Internet server 120 may operate as a single entity in a single geographic location or as separate computing components located together or in separate geographic locations.

Internet server 120 may provide a suitable web site or other Internet-based graphical user interface which is accessible by consumers. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and/or the like. A server may include a web service that receives a request from a web server, the request including a URL (e.g. http://yahoo.com/stockquotes/ge) and an IP address (e.g. 123.4.56.789). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

Middleware 130 may include any hardware and/or software suitably configured to facilitate communications and/or process transactions between disparate computing systems. Middleware components are commercially available and known in the art. Middleware 130 may be implemented through commercially available hardware and/or software, through custom hardware and/or software components, or through a combination thereof. Middleware 130 may reside in a variety of configurations and may exist as a standalone system or may be a software component residing on the Internet server 120. Middleware 130 may be configured to process transactions between the various components of TAMS 160 and any number of internal or external issuer systems 100 for the purposes disclosed herein.

In order to control access to any component of TAMS 160, Internet server 120 may invoke an authentication server (not shown) in response to consumer 105 submissions of authentication credentials received at Internet server 120 from web client 110. The authentication server may include any hardware and/or software suitably configured to receive authentication credentials, encrypt and decrypt credentials, authenticate credentials, and grant access rights according to privileges (e.g., pre-defined privileges) attached to the credentials. The authentication server may grant varying degrees of application and data level access to users based on information stored within a database and/or any other known memory structure.

AR database 140 and statement and billing database 155 may include any hardware and/or software suitably configured to facilitate storing data relating to, for example, transactions, statements, amounts owed, payments, payment type election, identification, authentication credentials, consumer permissions, consumer preferences, and the like. AR database 140 stores accounts receivable information and may also store payment information (e.g., method, amount, time, source of a payment). In one embodiment, payment information may be divided or parsed into separate data (e.g. attributes). Statement and billing database 155 stores billing and invoice information and, in one embodiment, also stores payment information, incentive information, incentive rewards (and related algorithms for determining the rewards), desired behavior attributes, etc. In one embodiment, Global Relationship Management Engine 150 interacts with statement and billing database 155, AR database 140 and/or other consumer information sources (such as consumer demographic data, consumer profile data, transaction account history, other consumer account data, a billing system, an accounting system, a transaction account authorization system, a collections system, an account management system, a customer relationship management system, a credit bureau, a third-party, a service provider, a merchant, a merchant system, etc.) to identify desired consumer behavior, determine incentives that may be offered to a consumer, determine incentive eligibility, evaluate positive behavior, make calculations for a reward associated with an incentive and forecast future consumer behavior and/or incentives, etc.

One skilled in the art will appreciate that system 100 may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of system 100, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with system 100 by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of system 100, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. System 100 contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of system 100 may consist of any combination thereof at a single location or at multiple locations, wherein each database or system 100 includes any of various suitable security features, such as firewalls, access codes, encryption, decryption, compression, decompression, and/or the like.

In addition to those described above, the various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the present invention. As those skilled in the art will appreciate, user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. User computer can be in a home or business environment with access to a network. In an exemplary embodiment, access is through a network or the Internet through a commercially-available web-browser software package.

As used herein, the term “network” shall include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the invention is frequently described herein as being implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards And Protocols (1998); Java 2 Complete, various authors, (Sybex 1999); Deborah Ray And Eric Ray, Mastering Html 4.0 (1997); and Loshin, TCP/IP Clearly Explained (1997) and David Gourley and Brian Totty, HTTP, The Definitive Guide (2002), the contents of which are hereby incorporated by reference.

The invention may be described herein in terms of functional block components, screen shots, optional selections and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and/or the like, which may carry out a variety of functions under the control of one or more microprocessors or other control devices. Similarly, the software elements of system 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that system 100 may employ any number of conventional techniques for data transmission, signaling, data processing, network control, and/or the like. Still further, system 100 could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, may be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

System 100 enables consumer 105 (e.g., small business consumer), to improve cash-flow management by utilizing a transaction instrument (or device), such as a charge card. System 100 combines unique payment features within one, singular product. Consumer 105 can utilize these cash flow management tools for all of their purchases at any merchant/vendor that accepts a particular transaction account.

As will be disclosed in greater detail herein, system 100 enables consumers to elect a charge account payment term according needs, preferences, financial objectives, etc. and/or in response to specific incentives offered by the account issuer relating to payment terms. While certain embodiments of the present invention are disclosed herein in terms of a business charge account or a credit account, practitioners will appreciate that the teachings of the present invention may be equally applicable interchangeably between these types of account and/or to other types of transaction accounts and/or lines of credit with minimal or no modification to the disclosed systems and processes.

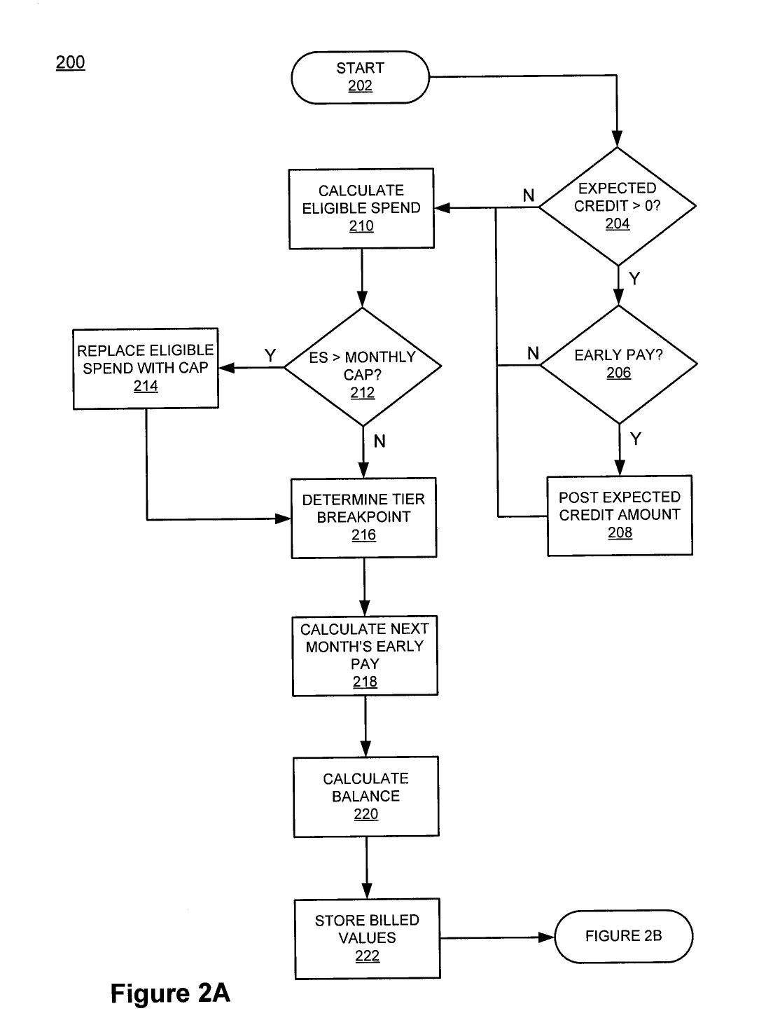

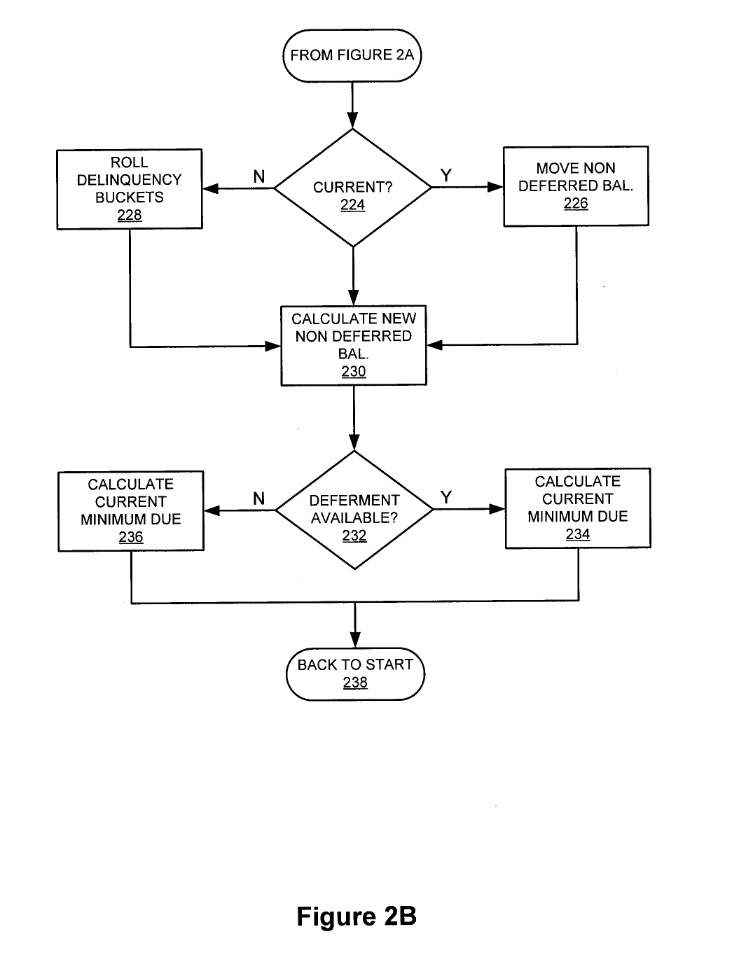

With reference to FIG. 2, system 100 may use the disclosed routines to appropriately process early payments. Practitioners will appreciate that system 100 may incorporate many commonly implemented accounting processes relating to, for example, maintaining accounts receivables and accounts payables. Therefore, such processes will not be discussed in detail herein.

At the close of a credit cycle for a transaction account, system 100 generates a billing statement (or “bill” or “account statement”) based on a number of factors associated with consumer transactional activities. The statement may include, for example, cycle start date, cycle end date, transaction date, merchant identifier, transaction amount, accrued interest, fees, account balance, available credit limit, total amount due, due date, and the like. The statement may be provided to consumer 105 online (e.g., email, accessible from a link, a customized uniform resource locator (URL), accessible at a website, sent to a PDA, etc), in paper form, via fax, mail or any other means known in the art. Consumer 105 may submit a payment to TAMS 160 via a check, cash, transfer of funds from another account, electronically by submitting a bank account number via an Automated Clearing House (ACH), or any other means known in the art.

The statement may further include an offer for an incentive, instructions for accepting the terms of the incentive and/or instructions regarding payment terms (e.g., incentive terms along with check boxes corresponding to each term). In another embodiment, consumer 105 may establish a connection with TAMS 160 by way of web client 110 to view a billing statement online. An interface is provided as disclosed herein, whereby consumer 105 may select a payment term. Consumer 105 may also accept the terms of an incentive and/or provide a payment term to TAMS 160 via billing statement stub, internet website, interactive voice response system and consumer service representative.

Consumer 105 may choose to pay an amount due earlier than the standard payment timeframe, in order to receive an Early Pay Discount. In one embodiment, Early Pay Discount allows consumer 105 to pay a new balance in full (or within a predefined threshold) by a pre-established early pay date to receive a discount off the current billed charges and may be awarded via a statement credit. Discounts may be supported from 0% through 100% and may be tiered. Such tiers may be based on one, or any combination of, for example, a payment amount, a spend amount, a payment date, a merchant identifier, an industry code, a location or region associated with a purchase, a transaction amount, a spend trend, a merchant relationship, the status of the consumer, the status of an account, an affiliation with an organization, a product held by the consumer, a purchase (e.g. of a specific product or at a particular merchant), the timing of a payment, time period for a purchase, a payment method, participation in a program, a payment history, the length of relationship between the consumer and an account, and a credit rating of the consumer. In an embodiment, a tier is determined according to a flat percent discount for any amount of spend. In various embodiments, Early Pay Discount may be awarded in the form of loyalty points, membership rewards points, prizes, rewards, gifts, packages, opportunities, adventure trips, entertainment, meetings with special people, special access passes, sporting events, cultural events, discounts on classifications of items, discounts on specific items, discounts on specific vendors, discounts within a defined geographical area, discounts within a consortium of merchants, and/or the like.

In one embodiment, with reference to FIG. 2A, when TAMS 160 receives an election for Early Payment Discount from consumer 105, TAMS 160 determines if the expected credit is greater than zero (204). If the expected credit is not greater than zero, then TAMS 160 calculates eligible spend (210) for the next cycle Early Payment credit. Specifically, TAMS 160 takes into consideration current spend data in light of net suspense and Early Pay credits in order to determine a consumer's available spend for the next cycle. Net suspense is derived from subtracting a decrease of the consumer's suspended balance from an increase of the consumer's suspended balance. A suspended balance is any balance that is under dispute by a consumer. A suspended balance is not eligible for finance charges and is not due until the dispute is resolved. In one embodiment, the calculation is: (net cycle-to-date purchase activity)−(net suspense)+(early pay credits−early pay debits)

Thus, the above calculation may be used by TAMS 160 to determine the amount of spend in which consumer 105 is eligible in a subsequent credit cycle, as to not exceed a predetermined amount. However, practitioners will appreciate that the invention may use any number of various calculations and variables to determine an optimal spend availability in accordance with the present invention.

If the expected credit is greater than zero (step 204), then system 100 determines whether the selected payment term option is for Early Payment (206). If Early Payment is not selected by consumer 105, then TAMS 160 calculates eligible spend (210) for the next cycle Early Payment credit as described above. However, if consumer 105 selects the Early Payment term, then the expected credit amount is posted as Early Payment credit (step 208). In one embodiment TAMS 160 adds the credit amount to a cycle-to-date field within statement and billing database 155. The cycle-to-date amount may include issued Early Payment credits, year-to-date credits, and credits earned over consumer's participation in the program. TAMS 160 further calculates eligible spend (210) for the next cycle Early Payment credit as described above.

Practitioners will appreciate that transaction account issuers use a variety of methods to determine spend limits for consumers. Some assign an overall spend limit associated with a particular charge account. In other words, consumer may spend any amount in a given month as long as the spend amount falls within the overall credit limit. Other account issuers assign a monthly spend limit that is based on a number of factors relating to consumer such as, for example, credit rating, spending trends, payment history, length of time as a consumer, and the like. In some instances, the spend limit, or cap, may fluctuate during any time period based on these and other factors. Therefore, at the end of each cycle, the account issuer may use any number of calculations to determine a spend cap to be placed on the next cycle. In other instances, a spend cap is more static in nature and may be subject to periodic review and adjustment by the account issuer.

With reference again to FIG. 2A, in step 210 if TAMS 160 calculates an eligible spend that exceeds a consumer's monthly cap (step 212), then the eligible spend amount is replaced by the monthly cap (step 214). In one embodiment, TAMS 160 awards Early Pay credits based on tiers. Such tiers may have associated therewith, a discount rate that is based on any number of factors such as, for example, an eligible spend amount. In one embodiment, TAMS 160 determines a tier breakpoint to which the consumer 105 spend amount corresponds (step 216). An Early Pay credit may then be calculated by multiplying the tier's discount rate by the eligible spend (step 216). In another embodiment, other factors may be considered for the calculation of an Early Pay discount rate. For example, an account issuer may partner with an airline for promotions. As such, TAMS 160 may factor in an amount of consumer spend with the partnered airline to issue an even higher Early Pay discount. Other spend factors may include, for example, classifications of items, specific items, specific vendors, a defined geographical area, a consortium of merchants, a payment amount, a spend amount, a payment date, a merchant identifier, an industry code, a location or region associated with a purchase, a transaction amount, a spend trend, a merchant relationship, the status of the consumer, the status of an account, an affiliation with an organization, a product held by the consumer, a timing of a payment, time period for a purchase, a payment method, a participation in a program, the length of a relationship between the consumer and the account, and/or a credit rating of the consumer.

TAMS 160 also determines the dates that payments should be sent and received in order to qualify consumer 105 for Early Pay credits for the next cycle (step 218). In one embodiment, an Early Pay eligibility date may be static in that it does not fluctuate from month-to-month. For example, the account issuer may simply require that payment must be received on or before the fifth business day prior to the regular payment due date. In another embodiment, the account issuer may base the Early Pay eligibility date on factors that may change periodically. For example, the Early Pay eligibility date may be based on the amount of spend during the previous cycle, the amount of Early Pay discount applied to the account during the previous cycle, a previous payment date, a previous payment amount, an account balance, a payment history, a spend amount, a payment date, a merchant identifier, an industry code, a location or region associated with a purchase, a transaction amount, a spend trend, a merchant relationship, the status of the consumer, the status of an account, an affiliation with an organization, a product held by the consumer, a timing of a payment, time period for a purchase, a payment method, a participation in a program, the length of a relationship between the consumer and the account, and/or a credit rating of the consumer.

The amount that consumer 105 must spend may be based on any number of factors such as, for example, the consumers account balance, the total spend from the previous cycle, overall transaction history, payment history, credit rating, and the like. In one embodiment, TAMS 160 calculates the balance that consumer 105 must spend to receive an Early Pay discount by subtracting suspense from the total outstanding balance (step 220). TAMS 160 stores billed values (step 222) within a historical Early Pay database table of statement and billing database 155. Moreover, billed values may be stored within cycle-to-date fields in an unbilled early pay table.

In one embodiment, a Defer Payment term enables consumer 105 to defer payment on new billed charges interest and penalty-free (or reduced) until the next billing cycle due date. This option may support a partial payment of 0 to 99%, or no partial payment. With reference to FIG. 2B, in one embodiment, statement processing proceeds to step 224 when consumer 105 elects to defer payment. TAMS 160 determines whether the previous amount due has been paid (step 224). If the minimum due has not been paid, then current non-deferred and deferred balances are moved to a thirty-days past due table. If the account is current, then TAMS 160 determines whether the non-deferred current balance is not equal to zero. If this is the case, then the non-deferred current balance is moved to a deferred balance and a deferment counter is incremented (step 226). In one embodiment, consumer 105 may be allowed to defer a balance a limited number of times. For instance, the account issuer may determine that all consumers are limited to three payment deferments in a calendar year. In another embodiment, the number of available deferments may be limited by factors relating to the consumer such as, for example, account balance, payment history, credit rating, exceeding monthly spending limits, and the like.

With reference again to FIG. 2B, in one embodiment, TAMS 160 calculates a new non-deferred balance (step 230) by subtracting a deferred balance, a delinquent due, and suspense from the total account outstanding balance. As explained above, deferment may be limited, thus system 100 determines whether a deferment is eligible (step 232). If no deferment is available, then TAMS 160 calculates the current minimum payment due (step 236) by adding the current non-deferred balance to the deferred balance and the account is flagged (e.g. by setting a flag or indicator in statement and billing database 155) as ineligible for deferment. However, if a deferment is available, then TAMS 160 calculates the current minimum payment due by multiplying the current non-deferred balance by a predetermined percentage amount and adding the result to the deferred balance and multiplying the sum by a fee amount.

The optional fee amount charged to the consumer may be any fixed amount or percentage that the account issuer determines to be appropriate. In one embodiment, the fee amount is fixed across consumers. In an embodiment, the fee may be determined dynamically, based upon a predetermined rule, on a case-by-case basis, etc. and may consider factors such as, for example, account balance, payment history, credit rating, exceeding monthly spending limits, a payment amount, a spend amount, a payment date, a merchant identifier, an industry code, a location or region associated with a purchase, a transaction amount, a spend trend, a merchant relationship, the status of the consumer, the status of an account, an affiliation with an organization, a product held by the consumer, a timing of a payment, time period for a purchase, a payment method, a participation in a program, the length of a relationship between consumer and the account, and/or a credit rating of consumer. According to one fixed fee embodiment, the current minimum due may be calculated by adding the current non-deferred balance, the deferred balance, and fee amount. In one embodiment, payment processing completes for a given consumer and TAMS 160 returns to process the next statement (step 202).

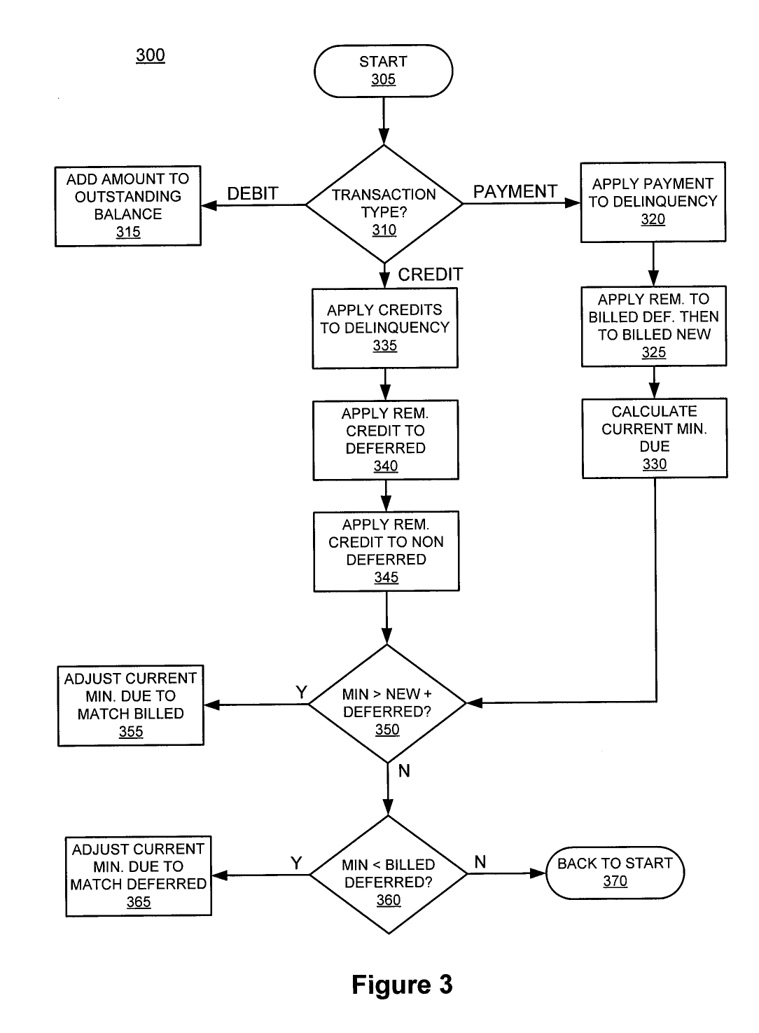

In one embodiment for payments deferred as described above, posting activities may be modified in light of the differences between delinquent accounts and deferred payments. Referring to FIG. 3, the posting process (step 305) begins with a determination of a transaction type (step 310). If the transaction is a debit transaction (e.g., a charge account purchase), the transaction amount is added to an outstanding balance, a cycle-to-date balance, and current balance within AR database 140.

In one embodiment, when processing a credit transaction (e.g., a returned item), the full credit amount is used to offset a delinquency amount if present (step 335). If there is no delinquent amount or if the credit is more than the amount needed to settle a delinquency, the remaining credit amount is applied to a deferred balance, if one exists. TAMS 160 subtracts 100% of the amount applied to the deferred balance from the current amount due (step 340). If any portion of the credit remains, the credit portion is applied to a non-deferred balance (step 345). In an embodiment, this credit portion may be multiplied by the account's defer pay option due rate that is used to calculate the current defer pay option amount due in the prior cycle (e.g. 10% or 100%) and is subtracted from the current minimum payment due.

In one an embodiment for a payment transaction type, the payment amount is applied to offset any delinquency that may be present (step 320). If there is no delinquency or if the payment amount exceeds the delinquency amount, then the remaining payment amount is used to offset a billed deferred amount and/or a new deferred amount (step 325). In one embodiment, TAMS 160 combines the amount deferred to the billed deferred and new deferred and offsets the minimum due by the sum of the two.

TAMS 160 performs a consistency check to adjust the current minimum due. If the current minimum due is greater than the sum of the new minimum due and the deferred amount (step 350), then the current minimum due is adjusted to match the total amount billed (step 355). A check is performed to determine if the current minimum due is less than the billed deferred amount (step 360, then the current minimum due is adjusted to match the deferred amount (step 365).

One embodiment includes a payment term option is to submit a Standard Payment, which allows consumer 105 to pay a new balance in full by a pre-defined number of days after a statement cycle is cut. Practitioners will appreciate that various account issuers process “standard” payments in a variety of ways. Such standard processing may include, for example, processing payments that are required to pay the full account balance within 30 days, payments made over time with a minimum amount due each month, assessing an interest charge on an unpaid balance, and the like.

The present system may similarly be applied to incentivize transaction account consumers to make early payments, as well as exhibit other desirable payment behavior. Accordingly, various embodiments of the present invention directed toward incentivizing consumers to, for example, make an early payment, pay more than a minimum amount due, pay an amount equal to at least a predefined percentage of an outstanding balance, opt out of paper invoice delivery, opt for electronic billing, opt for automatic payment scheme and/or the like according the needs/preferences of the consumers and/or in response to specific incentives offered by the account issuer relating to payment terms. While disclosed herein in terms of a credit card or account, practitioners will appreciate that the present invention may be equally applicable to other types of transaction accounts and/or lines of credit with minimal or no modification to the disclosed systems and processes.

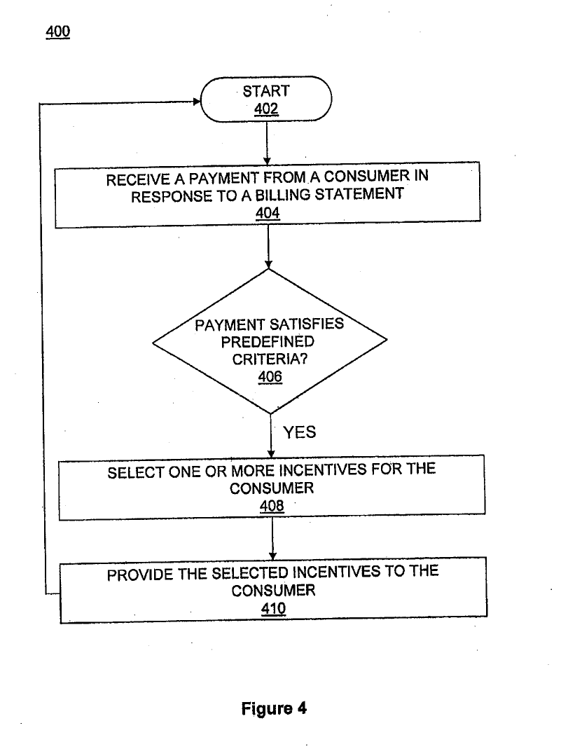

Referring now to FIG. 4, at the close of a credit cycle for a transaction account, system 100 generates a billing statement based on a number of factors associated with consumer transactional activities. The statement may include, for example, cycle start date, cycle end date, transaction date, merchant identifier, transaction amount, accrued interest, fees, account balance, available credit limit, total amount due, minimum amount due, due date, and the like. In an exemplary embodiment of the invention, the billing statement may also include one or more pre-defined criteria (e.g., desired behavior or desired behavior attribute) that consumer's 105 payment needs to satisfy in order to be eligible for to receive an offer for an incentive and/or to receive the reward associated with an incentive. The one or more pre-defined criteria may include, for example, making the payment earlier than the due date, paying more than the minimum amount due to be paid by consumer 105, paying through an automatic payment channel, for example, via an Automated Clearing House (ACH), and/or the like. The billing statement may further specify incentives that consumer 105 may receive for satisfying the one or more pre-defined criteria. The statement may be provided to consumer 105 online (e.g., email, accessible from a link, accessible at a website, sent to a PDA, etc) or in paper form, or via fax, mail or any other means known in the art.

After receiving the payment from consumer 105 (step 404), TAMS 160 checks the received payment, and the payment information (e.g., payment date) to determine whether it satisfies the one or more pre-defined criteria (step 406). When the payment satisfies the one or more predefined criteria, TAMS 160 selects one or more incentives for consumer 105 (step 408). In one embodiment, TAMS 160 selects one or more incentives by evaluating predetermined rules, billing history, transaction history, payment terms for the transaction account, eligibility rules, etc.

Rewards associated with the incentives may include one or more of a lower Annual Percentage Rate (APR), a discount on the finance charges, a rebate on finance charges, a cash bonus, a cash-back amount, membership reward points, reduced renewal fee, achievement credit toward a future incentive, increased credit line, increased spend line, statement credit, gift vouchers, gifts, special privileges, special access passes (e.g., back-stage pass) and/or any other action, non-action, item or the like which may be considered a benefit. The incentives may be selected using a tiered incentive model. In one embodiment, an achievement credit comprises a credit or increment of a balance. For example, an incentive may be offered for paying a certain amount of the bill every month for six consecutive months and an achievement credit is added to the balance associated with tracking the customer's progress toward achieving this goal. Incentive rewards may include a discount and/or a rebate. In one embodiment, a discount is a reduction in the amount of finance charges accrued (or fees assessed) on the transaction account. A rebate may be a refund and/or credit of a portion of finance charges accrued (or fees assessed) on the transaction account. For example, a rebate may be sent to a customer (or credited to a customer account) several months after desired behavior criteria for an incentive have been satisfied.

The selected incentives are provided to consumer 105 (step 408). In various embodiments, TAMS 160 may provide the selected incentives to consumer 105 by updating its internal databases (e.g., statement and billing database 155, AR database 140, etc.) as well as communicating the incentive information to consumer 105 through various means known in the art. For example, TAMS 160 may adjust future billing statements of consumer 105, update consumer's 105 transaction account to reflect the incentives that the consumer has accrued, and/or send consumer 105 incentive related communication in subsequent billing statements or separately via email, facsimile or post.

In various embodiments, system 100 may use process 400 to appropriately process payments for providing incentives to the consumers. Practitioners will appreciate that process 400 may include many known, commonly implemented accounting processes relating to, for example, maintaining accounts receivables and accounts payables. Therefore, such processes will not be discussed in detail herein.

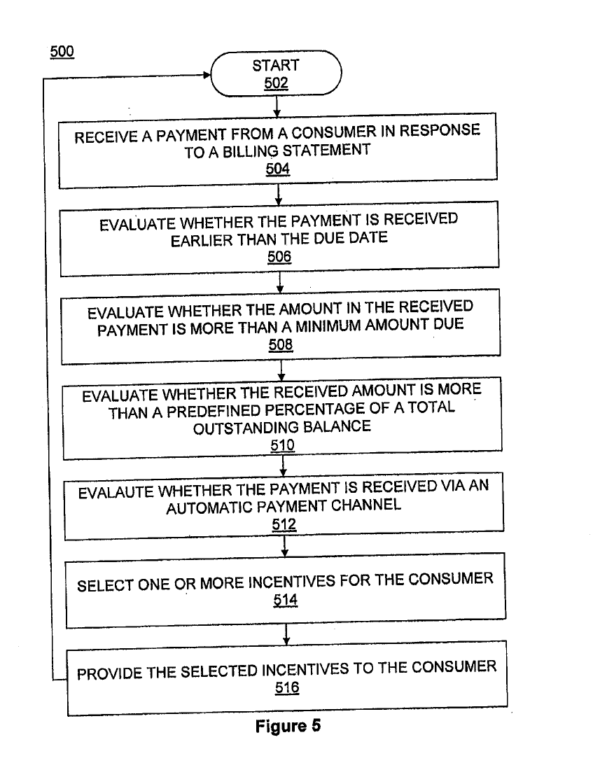

Referring now to FIG. 5, process 500 illustrates an exemplary implementation of process 400, according to one embodiment of the present invention. TAMS 160 receives payment (step 504) from consumer 105 corresponding to the billing statement. The consumer 105 may submit a payment to TAMS 160 via a check, cash, transfer of funds from another account, electronically by submitting a bank account number via an Automated Clearing House (ACH), or any other means known in the art.

Thereafter, TAMS 160 evaluates whether the received payment satisfies at least one of the one or more pre-defined criteria, for example, in an embodiment, TAMS 160 may check whether the payment was received earlier than the due date (step 506). TAMS 160 checks whether the amount received in the payment is more than the minimum amount due (step 508). TAMS 160 may also calculate the difference between the amount received in the payment and the minimum amount due. TAMS 160 calculates whether the received payment amount is more than a pre-defined percentage of the total outstanding balance (step 510). In one embodiment, TAMS 160 may check whether the payment was received via an automatic payment channel such as the ACH (step 512). In various embodiments, TAMS 160 may perform any one of steps 506-512 to evaluate whether the received payment satisfies the one or more pre-defined criteria.

In one embodiment, as discussed previously, an incentive includes one or more desired consumer behavior and/or desired consumer attributes that are used in determining when a consumer has satisfied the desired consumer behavior. TAMS 160 interprets good behavior from the payment, the payment information and from other information associated with the transaction account or the consumer. For example, good behavior may be associated with the total amount that a consumer remits for payment. If a payment is received for $50, TAMS 160 parses the payment and payment information and stores attributes that are used to evaluate satisfaction of good behavior criteria. TAMS 160 may parse and store attributes such as total remittance, total remittance for past three months, payment received in excess of a minimum, payment on time, payment received is greater than x % of outstanding balance, etc. In one embodiment, payment information (or the attributes derived from the payment information) is used in a calculation or to increment a counter or balance. For example, if the desired good behavior is that a consumer remit more than the minimum payment due for three consecutive billing cycles, TAMS 160 may increment a counter that tracks progress toward achieving this goal (i.e., apply an achievement credit by incrementing the counter and/or increment a total remittance balance). In various embodiments, TAMS 160 may perform all of steps 506-512 and may include other steps not illustrated in FIG. 5. In further embodiments, TAMS 160 may perform a subset of steps 506-512 and may include other steps not illustrated in FIG. 5. A person skilled in the art will appreciate that these steps may be performed in any order and that any other suitable criteria may be used, instead of or in addition to the criteria described herein, for monitoring desirable payment behavior of consumers.

TAMS 160 selects one or more incentives for consumer 105 based on the one or more pre-defined criteria satisfied by the payment (step 514). For example, if in step 506, TAMS 160 determines that the payment was received earlier than the due date, TAMS 160 may determine eligibility for a $10 statement credit reward (i.e., TAMS 160 calculates and applies the reward associated an incentive). Also for example, if in step 508, TAMS 160 determines that the received payment amount was more than the minimum amount due, TAMS 160 may choose to offer an incentive that will reward double membership reward points on amounts paid above the minimum amount due if the consumer continues to pay more than the amount due for a number of months. In another exemplary embodiment, if in step 510, TAMS 160 calculates that the received payment amount is more than the pre-defined percentage of the total outstanding balance, TAMS 160 may opt to charge a reduced APR on the remaining balance. In one embodiment, the pre-defined percentage may be set to 30%. Further, in one exemplary implementation, if in step 512, TAMS 160 determines that the payment was received through an automatic payment channel, TAMS 160 may select a gift voucher of $25 for consumer 105. In some embodiments, more than one type of incentive may be also be selected when the received payment satisfies one of the pre-defined criteria. For example, TAMS 160 may choose to offer 5% cash back on the amount paid above the minimum amount due in addition to the double membership reward points mentioned above.

In an embodiment, when the received payment satisfies more than one pre-defined criteria, TAMS 160 may select incentives corresponding to each of the satisfied criteria or may select incentives based upon a combination (e.g., aggregate analysis) of the criteria. For example, if the payment is received earlier than the due date and also the received payment amount is more than the pre-defined percentage of the total outstanding balance, TAMS 160 may opt to provide $10 statement credit as well as charge the reduced APR on the remaining balance. According to various embodiments, in such cases, TAMS 160 may opt to provide additional incentives to consumer 105, for example, giving additional $50 statement credit, selecting a gift voucher of $20, increasing the credit limit and/or the like.

In an embodiment, pre-defined criteria may be associated with a balance (or variety of data) stored in a database. When a payment is received the balance associated with a pre-defined criteria may be incremented based upon a pre-defined calculation. For example, if the pre-defined criterion involves whether a particular percentage of the outstanding balance is paid over the course of several months, the balance is a counter and the counter may be incremented when future payments are received.

In an embodiment, TAMS 160 selects the one or more incentives using a tiered incentive model. For example, TAMS 160 may give $10 statement credit if the payment is received 2 to 5 days earlier than the due date, $20 statement credit if the payment is received 6 to 10 days earlier than the due date, and $50 statement credit if the payment is received more than 10 days earlier than the due date. In various embodiments, TAMS 160 may determine tiers on the basis of, for example, a payment amount, a spend amount, a payment date, a merchant identifier, an industry code, a location or region associated with a purchase, a transaction amount, a spend trend, a merchant relationship, the status of the consumer, the status of an account, an affiliation with an organization, a product held by the consumer, a purchase (e.g. of a specific product or at a particular merchant), the timing of a payment, time period for a purchase, a payment method, participation in a program, a payment history, the length of relationship between the consumer and an account, and a credit rating of the consumer. A person skilled in the art will recognize other such suitable tiers may be defined for providing incentives in response to the received payments satisfying one or more pre-defined criteria without deviating from the spirit and scope of the invention.

In an example embodiment of the present invention, the selection of incentives may also depend on various other factors, for example, a payment amount, a spend amount, a payment date, a merchant identifier, an industry code, a location or region associated with a purchase, a transaction amount, a spend trend, a merchant relationship, the status of the consumer, the status of an account, an affiliation with an organization, a product held by the consumer, the timing of a payment, time period for a purchase, a payment method, participation in a program, the length of relationship between consumer and an account, and a credit rating of consumer.

TAMS 160 provides the selected incentives to consumer 105 (step 516). In an embodiment, if at step 504, TAMS 160 determines that none of the pre-defined criteria are satisfied by the received payment, consumer 105 is not provided any incentives. In one embodiment, when the payment processing depicted in FIG. 5 is complete for a given consumer, TAMS 160 returns to process the next statement (step 502).

In various embodiments, consumer 105 may become eligible for incentives if the one or more pre-defined criteria are satisfied by at least two payments received from consumer 105. The at least two payments may correspond to successive billing cycles or the at least two payments may be distributed over a pre-defined period, for example, a calendar year. In one implementation, TAMS 160 may provide incentives to consumer 105 if three successive payments are received earlier than the due date or TAMS 160 may provide incentives to consumer 105 if consumer 105 pays more than the minimum amount due for at least six payments in a calendar year.

In one embodiment, incentives are offered to influence or encourage certain consumer behavior. TAMS 160 analyzes consumer information associated with a consumer and identifies a positive behavior that the consumer demonstrates or, as determined by TAMS 160 logic (e.g. global relationship logic engine 150), positive behavior that the consumer has the potential to, or is forecasted to, exhibit. Thus, TAMS 160 determines an incentive that is designed to encourage or reinforce the positive behavior by providing a reward to the consumer. For instance, consumer information (e.g., accounts receivable information in AR database 135) may indicate that a consumer often pays a substantial amount of the outstanding balance on a transaction account within 15 days of receiving a bill. TAMS 160 queries an incentives database to find an incentive that offers a reward based upon similar behavior.

Incentives may be stored in an incentives database and, in various embodiments, may be stored, for example, in the statement and billing database 155. In one embodiment, once an incentive is assigned to (or offered to and accepted by) a consumer, the incentive is associated with the consumer profile of the consumer. Furthermore, in addition to having a positive behavior and award associated with it, an incentive may further have eligibility rules associated with it. For instance, an incentive may be associated with the positive behavior of paying off the current charges on a bill for a transaction account and the incentive may provide to the consumer, as a reward for exhibiting such positive behavior, a lower interest rate on the outstanding balance. Moreover, an eligibility rule associated with the incentive may dictate that the incentive only be offered to consumers who have opened a transaction account within the past year. Analyzing the consumer information, TAMS 160 matches attributes associated with the consumer with pre-defined criteria (or attributes) associated with exhibiting (or “satisfying”) the positive behavior. In one embodiment, TAMS 160 may identify multiple positive behaviors and match each of those positive behaviors with multiple incentives to offer the consumer. Furthermore, in various embodiments, eligibility to receive an offer for an incentive, or the reward associated with the incentive may be determined by exhibiting attributes associated with multiple positive behaviors. For example, payment information associated with a payment may indicate that the payment was received early (positive behavior attribute associated with a desired behavior of early payments) and that the payment was in an amount greater than 80% of the outstanding balance (positive behavior attribute associated with paying down a balance on a transaction account).

In one embodiment, TAMS 160 determines that a consumer is eligible to receive an incentive and produces output to offer the incentive to the consumer. For instance, the consumer may be sent an email with the incentive information and provide a customized URL that, if selected by the consumer, signs the consumer up for the incentive. In one embodiment, upon determining that the consumer is eligible for an incentive, TAMS 160 (and/or an associated billing engine) automatically calculates a bill for the transaction account based upon the reward associated with the incentive and provides the bill to the consumer. For example, if the reward is a lower APR, the interest on the bill is calculated based upon the lower APR.

Positive behavior can be associated with any of the positive behaviors described herein. In one embodiment, positive behavior includes one or more of (or any portion thereof): paying a bill earlier than a due date, paying the bill on-time or paying the bill within a predefined timeframe, paying an amount for a bill that is more than a minimum amount due for the bill, paying an amount for the bill more than a percentage of a total outstanding balance indicated on the bill, paying a total amount over several billing cycles, or paying the bill through an automatic payment channel.

A reward may be associated with one or more incentive. A reward may be relatively simple to determine (e.g., $10 cash back) or may be based upon a complex calculation with multiple data inputs for multiple data sources. For instance, calculating a reward may involve determining an interest rate that is based upon the interest rate of two related transaction accounts and further lowering the interest rate by a percentage determined by a tiered interest rate schedule. In various embodiments, rewards may include one or more of (or any portion thereof): a lower Annual Percentage Rate (APR), an achievement credit toward a lower APR, a discount on finance charges, a rebate on finance charges, a discount on fees, a rebate on fees, a cash bonus, a cash-back amount, loyalty points, an increased credit line, an increased spend line, a statement credit, a gift voucher, loyalty points, an accumulation of a balance associated with a second incentive, an increased credit line, increased spend line, a statement credit, a gift voucher, waiving an annual fee associated with a consumer account, upgrading status of account consumer account, upgrading status of a second consumer account, upgrading the status of a third-party account, providing access to a club, providing access to a website, providing access to discounted products, upgrading a consumer account to a VIP status, providing a preferred bidding status to an item in an auction, providing a preferred access to an item in an auction, providing a loaded smart card, or paying the consumer an interest amount based upon the early payment amount.

In one embodiment, an incentive is designed such that the positive behavior is at least partially determined by activity (e.g., payments) and/or actions (e.g., transactions) associated with a first account while the reward for the positive behavior is awarded to a second account. For instance, one incentive comprises increasing the spend line (i.e., the reward) of a second transaction account if a consumer reduces the balance (i.e., the positive behavior) of a first transaction account. In various embodiments, positive behavior may be associated with making a payment for a first transaction account, reducing the balance of the first transaction account by a predetermined percentage, reducing below a predetermined threshold the balance of the first transaction account, reducing to zero the balance of the first transaction account or transferring a balance of a second transaction account to the first transaction account. Additional details regarding managing transactions involving multiple accounts are disclosed in U.S. application Ser. No. 12/242,803, entitled “Systems And Methods For Facilitating Transactions Between Different Financial Accounts” and filed on Sep. 30, 2008, which is hereby incorporated by reference in its entirety.

In one embodiment, TAMS 160 enables commercial transactions involving the exchange of monetary value for goods, services, or other value between remote individuals, such as users of a distributed computer network or Internet users. For instance, a positive behavior of a first consumer may earn a reward of paying a second consumer (e.g., if the first consumer owes money to the second consumer). The present invention also provides remote purchasers with means for making a secure, confidential transfer of funds; means for immediate initiation of shipment by a seller; means for releasing funds to a seller only after approval of the goods, services, or other value received from the seller; means for demonstrating proof of payment; and means for having some level of recourse against a remote seller. More particularly, the invention facilitates commercial transactions by suitably coordinating the transfer of financial tender from a financial account associated with a first party to a financial account associated with a second party in exchange for the transfer of goods, services from a second party to a first party and/or as a reward for positive behavior by a first party. Additional details are disclosed in U.S. application Ser. No. 12/242,759 entitled “Systems And Methods For Facilitating Transactions” and filed on Sep. 30, 2008, which is hereby incorporated by reference in its entirety.

In one embodiment, determining an incentive, eligibility for an incentive, positive behavior associated with an incentive, and/or a reward associated with exhibiting the desired behavior associated with an incentive are at least partially based upon a structural risk analysis. Outputs of a total structural risk model can be used in any business or market segment that extends credit or otherwise needs to evaluate the creditworthiness of a particular consumer. As such, incentivizing positive behavior based upon a structural risk analysis allows a transaction account issuer to offer credit terms and make credit decisions regarding existing consumers and increase business with business partners.

Modeling consumer risk includes, in one embodiment, obtaining consumer data, modeling and/or processing the consumer data, and creating an output. The output may then be used to make business decisions. In various embodiments, the present invention uses a variety of data (e.g., consumer data) in conjunction with several modeling/processing procedures to assess risk.

A debt obligation includes any obligation a consumer has to pay a lender money. Any extension of credit from a lender to a consumer is also considered a debt obligation. A debt obligation may be secured or unsecured. Secured obligations may be secured with either real or personal property. A loan or a credit account are types of debt obligations. A security backed by debt obligations is considered a debt obligation itself. A mortgage includes a loan, typically in the form of a promissory note, secured by real property. The real property may be secured by any legal means, such as, for example, via a mortgage or deed of trust. For convenience, a mortgage is used herein to refer to a loan secured by real property. An automobile loan includes a loan, typically in the form of a promissory note, which is secured by an automobile. For convenience, an automobile loan is used herein to refer to a loan secured by an automobile.

A lender is any person, entity, software and/or hardware that provides lending services. A lender may deal in secured or unsecured debt obligations. A lender may engage in secured debt obligations where either real or personal property acts as collateral. A lender need not originate loans but may hold securities backed by debt obligations. A lender may be only a subunit or subdivision of a larger organization. A mortgage holder includes any person or entity that is entitled to repayment of a mortgage. An automobile loan holder is any person or entity that is entitled to repayment of an automobile loan. As used herein, the terms lender and credit issuer may be used interchangeably. Credit issuers may include financial services companies that issue credit to consumers.

A trade or tradeline includes a credit or charge vehicle typically issued to an individual consumer by a credit grantor. Types of tradelines include, for example, bank loans, credit card accounts, retail cards, personal lines of credit and car loans/leases.

Tradeline data describes the consumer's account status and activity such as, for example, names of companies where the consumer has accounts, dates such accounts were opened, credit limits, types of accounts, balances over a period of time and summary payment histories. Tradeline data is generally available for the vast majority of actual consumers. Tradeline data, however, typically does not include individual transaction data, which is largely unavailable because of consumer privacy protections. Tradeline data may be used to determine both individual and aggregated consumer spending patterns, as described herein.

Internal data is any data a credit issuer possesses or acquires pertaining to a particular consumer. Internal data may be gathered before, during, or after a relationship between the credit issuer and the consumer. Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also for example, transaction vendor/merchant location may include a particular web address, such as a Uniform Resource Locator (“URL”), an email address and/or an Internet Protocol (“IP”) address for a vendor/merchant. Transaction vendor/merchant location may also include information gathered from a WHOIS database pertaining to the registration of a particular web or IP address. WHOIS databases include databases that contain data pertaining to Internet IP address registrations. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Internal data may further comprise closed-loop data and open-loop data. Closed-loop data includes data obtained from a credit issuer's closed-loop transaction system. A closed-loop transaction system includes transaction systems under the control of one party. Closed-loop transaction systems may be used to obtain consumer transactional data. Open-loop data includes data obtained from a credit issuer's open-loop transaction system. An open-loop transaction system includes transaction systems under the control of multiple parties.

Credit bureau data is any data retained by a credit bureau pertaining to a particular consumer. A credit bureau is any organization that collects and/or distributes consumer data. A credit bureau may be a consumer reporting agency. Credit bureaus generally collect financial information pertaining to consumers. Credit bureau data may include consumer account data, credit limits, balances, and payment history. Credit bureau data may include credit bureau scores that reflect a consumer's creditworthiness. Credit bureau scores are developed from data available in a consumer's file, such as the amount of lines of credit, payment performance, balance, and number of tradelines. The data available in a consumer's file is used to model the risk of a consumer over a period of time using statistical regression analysis. In one embodiment, those data elements that are found to be indicative of risk are weighted and combined to determine the credit score. For example, each data element may be given a score, with the final credit score being the sum of the data element scores.

In one embodiment, TAMS 160 determines or accesses consumer information that includes a comprehensive consumer default risk value for a consumer. One method comprises obtaining consumer credit data relating to the consumer, modeling consumer spending pattern of the consumer using the consumer credit data, and calculating the comprehensive consumer default risk value for the consumer based upon the consumer credit data and the consumer spending pattern. In one embodiment, the method includes obtaining internal data relating to the consumer and further calculating comprehensive consumer default risk value for the consumer based upon the internal data. In an embodiment, determining the default risk value of the consumer may also include receiving credit bureau data related to multiple accounts of the consumer and for a previous period of time, identifying balance transfers into, or out of, those accounts, discounting any spending identified for any of the accounts for any portion of the previous period of time in which a balance transfer to such account is identified, and estimating a purchasing ability of the consumer based on the credit bureau data and the discounting.

TAMS 160 analyzes consumer information and the comprehensive consumer default risk value to identify a desired consumer behavior, where the desired consumer behavior is associated with lowering the comprehensive consumer default risk value for the consumer. TAMS 160 develops an incentive that provides a reward to a consumer for lowering default risk (or some attribute associated with default risk) and identifies one or more attributes in the consumer information that can be used to determine when the desired behavior (i.e., lowering default risk) has been satisfied. TAMS 160 associates the incentive with the consumer (via, e.g., a consumer account or consumer information associated with the consumer). TAMS 160 produces output to notify the consumer of the incentive. In one embodiment, TAMS 160 accesses updated consumer information and determines that an attribute of the consumer information satisfies the desired consumer attribute associated with the desired consumer behavior for which the incentive is designed. TAMS 160 produces output based upon the incentive reward. For example, the output may include notifying the consumer of the reward, updating a transaction account based upon the reward, or updating a second account based upon the reward.

In various embodiments an incentive that is developed based upon the comprehensive consumer default risk value may have an reward associated with it that includes establishing a transaction account based upon the comprehensive consumer default risk value, allowing a balance transfer on a transaction account and/or changing an interest rate on a transaction account where the interest rate is determined based the comprehensive consumer default risk value.

As discussed previously, the TAMS 160 enables designing, implementing and managing incentives to influence consumers to modify their behavior (e.g., improve timeliness of payments) and to reward consumers (e.g., a lower APR) for exhibiting a positive behavior. In one embodiment, TAMS 160 includes incentives to encourage positive behavior associated with a consumer making purchases at pre-determined geographic locations and/or services and goods offered in a specific geographic area. In addition to encouraging (and assessing) positive behavior associated with activity (e.g., a purchase transaction) in a geographic area, TAMS 160 also facilitates the development of incentives with market specific rewards and consumer communications to inform the consumer of the rewards. For example, positive behavior may be determined for activity within one geographic location and an award of loyalty points may be rewarded where the loyalty points must be redeemed in a second geographic location, a subset of locations or without restrictions. Similarly, the loyalty points may be earned in one geographic location, a subset of locations or without restrictions, then redeemed only in a specific geographic location. The geographic area information may be associated with the consumer, merchant, processing system and/or any other part of the overall system. The system may also facilitate the earning and redemption of points based upon product and/or service type. The system may also incorporate a conversion module which may convert the value of the loyalty points or value of the products/services based on the geographic area exchange rates.

The invention includes a method for facilitating earning loyalty points, wherein the loyalty points are associated with a geographic area, and the method includes: receiving purchase data; determining a geographic area related to the purchase data; determining an amount of geographic area loyalty points based on the geographic area information and purchase data; and updating the loyalty account with the geographic area loyalty points. Receiving purchase data may include: receiving and storing manufacturer item identifiers; receiving and processing a consumer ID; receiving and processing purchase data, wherein the purchase data comprises a retailer item identifier; associating at least two of consumer ID, purchase data, and a manufacturer item identifier; and performing an analysis that is dependent upon the step of associating.

The invention also facilitates redeeming loyalty points, wherein the loyalty points are associated with a geographic area, by maintaining a database for storing geographic area loyalty points in a loyalty account corresponding to a participant; receiving a request related to a requested geographic redemption area to redeem an amount of the geographic area loyalty points; determining if the requested geographic redemption area is associated with the geographic area loyalty points; and, adjusting the loyalty account based upon the amount of geographic area loyalty points.

The invention further includes redeeming said geographic area loyalty points in a pre-determined geographic area. The determination of a geographic area may be accomplished by using at least one of: zip codes, retailer identification codes, retailer item identifier, store identifier, warranty data, service establishment codes, SKU codes, UPC manufacturer codes, consumer ID, retailer ID, manufacturer ID, purchaser profile, consumer enrollment data, retailer loyalty identifier, consumer account, aggregate consumer account, consumer profile, supplementary member profile, and third party provider information. Calculating the geographic area loyalty points may include using at least one of a formula, ratio, percentage, consumer level, global positioning system information, point level, retailer level, manufacturer level, and reward level. The method may be implemented by an interactive, online computer system and may further include informing a consumer of the loyalty points in real-time at a point-of-sale, a suggestive sale in a geographic area, pooling, gifting and transferring the geographic area loyalty points or receiving purchase data includes receiving consumer data from a dual use transaction card. More details regarding geographic systems and loyalty point systems which may be incorporated into various embodiments of the present invention are disclosed in U.S. patent application Ser. No. 10/708,570 entitled “Geographic Loyalty System And Method” and filed on Mar. 11, 2004; U.S. patent application Ser. No. 10/304,251 entitled “System And Method For The Transfer Of Loyalty Points” filed on Nov. 26, 2002, U.S. Pat. No. 7,398,225 entitled “System And Method For Networked Loyalty Program” filed on Apr. 17, 2001; and, U.S. Pat. No. 7,398,226 entitled “System And Method For Networked Loyalty Program” filed on Nov. 6, 2001, which are hereby incorporated by reference in their entirety.

Systems and methods of rewarding positive behavior include a savings program which creates discounts on transactions at specific, program-enrolled merchants and/or based upon consumer spending. In one embodiment, TAMS 160 enables systematic and automatic discount to consumers when they use their transaction account for payment. As a reward for exhibiting a positive behavior such as paying a bill early or paying off the outstanding balance on a transaction account, a discount is systematically initiated simply by the consumer's use of the transaction account at an enrolled merchant. In other words, as part of an award for exhibiting a positive behavior, consumers receive consistent discounts off of the full (gross) amount of the transaction from each enrolled merchant. Such discounts may be reflected on the consumer's monthly statement, and may also accumulate and aggregate discounts or information related to the discounts. In addition, merchants may also receive statements detailing how and for what goods and/or services discounts were given to consumers. This feature is advantageous to the issuer because it provides the ability to incentivize the consumer to exhibit a desired positive behavior by offering (and/or rewarding) better embedded card benefits. One benefit to merchants of this feature is the ability to drive additional business (e.g., incremental volume and new consumer acquisition), build brand equity through an innovative marketing program, and participate in an innovative marketing program at little or no additional technology expense. Consumers benefit from the automated discounting features it provides the ability to gain meaningful benefit and savings from merchant partners by simple use of the account, the ability to see immediate and tangible savings on monthly statement, guaranteed combinability of savings, and discounting on full amount of transaction (including any taxes or surcharges). Consumers also are able to see credits on their statement and receive accumulated, detailed and aggregate savings information. Additional details of such automatic discounting and consumer savings features are disclosed in U.S. application Ser. No. 11/161,906, entitled “Card Member Discount System And Method” and filed on Aug. 22, 2005, which is hereby incorporated by reference in its entirety.

As discussed above, in various embodiments, TAMS 160 evaluates data and constructs models associated with structural risk, such as consumer default risk when developing, offering and allocating rewards for incentives. In an embodiment, TAMS 160 analyzes consumer information for multiple customers, such as all customers in a segment or with a particular profile. Thus, TAMS 160 enables account issuers the ability to identify consumer that exhibit a negative behavior and develop incentives that provide rewards to the consumers if the negative behavior is modified (i.e. by exhibiting a desired behavior). For example, consumer information may identify a target group of consumers that often make late payments on their transaction accounts in the first quarter of a calendar year. TAMS 160 analyzes the consumer information and determines that offering a lower annual percentage rate on an outstanding balance may not be the type of reward that will influence these customers to make payments on time. This determination may be made based upon historical data for the target group and/or historical information for consumers outside of the target group but that share a particular attribute in common with the target group. TAMS 160 may further determine that the prospect of receiving a rebate (i.e., the reward) on items purchased at an electronics store during the month of December may influence consumers in the target group to make payments on time (i.e., the desired behavior) for bills sent out in January and February. However, the TAMS 160 may also determine that the benefit to the account issuer of this incentive will be maximized if it is offered to customers who have an annual income within a certain range (i.e., the eligibility rule).

Thus, as illustrated in this example, a method includes obtaining, by a computer, consumer information associated with a plurality of consumers, where each consumer in the plurality of consumers is associated with a transaction account; analyzing, by the computer, the consumer information to identify a negative consumer behavior associated with at least a subset of the plurality of consumers; developing, by the computer, an incentive designed to influence the subset of the plurality of consumers to modify their behavior to a positive consumer behavior; determining, by the computer, that a first consumer satisfies an incentive eligibility rule, wherein the determining comprises analyzing consumer information associated with the first consumer and wherein the incentive comprises an incentive eligibility rule; updating, by the computer, the consumer information associated with the first consumer to associate the first consumer with the incentive; and producing, by the computer, output based upon the incentive in order to provide notice to the first consumer of the incentive.

Not only does TAMS 160 enable development of incentives designed to modify consumer behavior, but it also provides automated customer relationship and account management features that enable efficient and effective administration, maintenance, distribution and communication of the incentives. For example, in various embodiments an incentive is developed and offered to a consumer. However, in order to take effect, the consumer accepts the terms of the incentive (e.g., due to contractual or regulatory requirements). TAMS 160 provides a multitude of capabilities designed to allow the consumer to receive, review and indicate acceptance of the terms associated with an incentive. For example, in one embodiment incentives are presented to a consumer on a web portal and the consumer accepts the terms via the web portal, a mobile device (e.g., by texting a code to a number indicated on the web portal), voice data, a facsimile or postal service. Furthermore, in various embodiments, TAMS 160 may notify a consumer of the incentive via an email message, a short message service (SMS) message (text message), a message on a consumer portal, an electronic bill, a voice message, a facsimile, a letter, or a consumer notification message. In an embodiment, a consumer receives a text message on a mobile device and the text message, in addition to explaining the incentive's terms and the reward(s) associated with the incentive, also includes a customized uniform resource locator (URL). The consumer accepts the terms associated with the incentive by selecting the customized URL. In an embodiment, the consumer redeems a reward associated with the incentive by selecting the customized URL; for example, the reward may include access to discounted products at a merchant website and the customized URL provides access to the discounted products.

In an embodiment, TAMS 160 enables marketing or product development personnel the ability to design a program or product that includes multiple incentives. TAMS 160 provides the ability for a consumer to register for the program, for example via a consumer portal, automatically associating the consumer and/or the transaction account with the incentives of the program.

In one embodiment, TAMS 160 also includes a post incentive offer and/or post incentive reward analysis tool to determine how, and to what extent, consumer behavior may have been modified as a result of an incentive. The change in behavior that is analyzed can be a negative change or a positive change and the analysis may include analyzing an effect of the incentive on a plurality of customers that received the incentive or analyzing behaviors of a plurality of customers that did not receive the incentive. In one embodiment, the tool generates new incentives based upon the analysis or upon the modified behaviors. An incentive may be associated with many consumers, many accounts for each consumer, multiple rewards, complex eligibility conditions, and complex and voluminous billing and collections data. For example, in order to receive a reward for an incentive a consumer may need to spend a certain amount on a first transaction account, pay down a balance on a second transaction account, and redeem points on a loyalty account.

Thus, conducting an analysis to determine the effectiveness of an incentive is a complicated and potentially resource intensive task. TAMS 160 and related tools and databases enable an organization (e.g., an account issuer) to track results associated with offering incentives and perform sophisticated prediction, statistical and simulation analysis to draw conclusions from the data. In one embodiment, the system obtains consumer information associated with a consumer, where the consumer is associated with a consumer account; analyzes the consumer information to identify a change in consumer behavior, determines that at least a portion of the change in consumer behavior is attributable to an incentive offered to the consumer; analyzes the change in consumer behavior to determine a strategy to affect future consumer behavior; and produces output based upon the strategy.

In various embodiments, the strategy may include: modifying an incentive eligibility rule to limit or expand the number and type of consumers, or type of transaction accounts, eligible for the incentive; modifying the terms of the incentive (e.g. date the incentive takes effect, purchases that contribute to an achievement goal, etc); modifying a consumer behavior attribute used to determine whether a desired consumer behavior is satisfied (reducing a payment timeframe, reducing a minimum balance, etc). In one embodiment, the analysis may indicate that the desired consumer behavior for an incentive was not realized because the reward associated with the incentive was not generous enough. For example, in one embodiment, modifying the terms of the incentive comprises lowering the APR (i.e., modifying the reward) for a transaction account and incrementing an achievement credit (i.e., modifying the desired behavior) where achieving the achievement goal will result in a still lower APR.

In one embodiment, incentives are related to loyalty accounts, earning loyalty points, redeeming loyalty points, receiving advanced loyalty points and receiving a cash advance associated with loyalty points. In various embodiments, as discussed above loyalty accounts may be associated with a desirable behavior (e.g. closing a loyalty account) or with a reward (e.g. receive loyalty points in a loyalty account for making an early payment). In various embodiments an incentive may also be associated with an advance of loyalty points or a cash value associated with an advance of loyalty points.

An exemplary system and method of the present invention is generally described, in terms of a transaction phase, a transaction authorization and settlement phase, and an account reconciliation phase. During the transaction phase, a loyalty program participant (e.g., a consumer) desiring to spend accumulated loyalty points selects products or services for purchase from an individual merchant or a shopping/redemption network of merchants. For example, in an online transaction, the participant may select a “pay with loyalty points” hyperlink button, thereby invoking a process to convert accumulated loyalty points to some currency value such as a credit to a participant's financial transaction account. After selecting a given product or service to purchase, the participant provides his or her transaction card number and the transaction is processed as with any other transaction. Additionally, in one embodiment, before the transaction is allowed to go forward, the account manager verifies that sufficient credit is available on participant's financial transaction account and/or sufficient loyalty points are available in participant's loyalty account. In this case, a charge authorization system is accessed to compare the transaction details with account information stored in the participant's loyalty account and the participant's transaction account.

During this verification process, the account manager's loyalty system middleware determines the appropriate number of loyalty points to use by implementing a conversion processor that converts the participant's loyalty points to an appropriate currency equivalent (e.g., 100 loyalty points=$1 US). For example, taking into account the 100 to 1 conversation ratio, if the transaction amount is $100.00, the loyalty point equivalent would be 10,000 points. If the participant confirms the use of designated loyalty points to complete the purchase, the participant's loyalty account is reduced by the appropriate number of loyalty points and the merchant proceeds with the transaction authorization and settlement phase to complete the transaction.

During the account reconciliation phase, the accounts receivable system reconciles the charge for the particular transaction with a credit from the participant's loyalty account. In one embodiment, for each charge where the participant selected to pay with loyalty points, there will be a corresponding and offsetting charge to the account. In another embodiment, where the account participant desires to pay only part of the transaction amount with loyalty points, the loyalty credit will only partially offset the merchant charge and the remainder will be paid with the participant's transaction card.

In one embodiment, an account participant is issued a number of advanced loyalty points to facilitate a purchase when a loyalty account balance is not sufficient to complete such a transaction. Using a number of preset rules and criteria, an account manger calculates a number of points available to an account participant as an advance. According to this point advance embodiment, the account participant may subsequently utilize the advanced loyalty points to purchase goods and/or services from the account manger or any merchant that accepts the loyalty points. The user is allotted a period of time for which to earn enough loyalty points to offset the loyalty point advances. If, at the end of the allotted period of time, a balance of advanced loyalty points has not been offset, then the account manager may charge the participant an amount equal to the currency value of the loyalty points at the time of the advance. In one embodiment, to determine the number of loyalty points available for advance, account manager may consider consumer information (e.g., participant and financial account attributes). These attributes may include, for example, the participant's account history, other parties responsible for the participant's account, the length of time the participant has been enrolled in the loyalty program, the product type associated with the loyalty account, the intended use of the points, and/or the like. For example, participants may be classified into tiers according to the type of financial instrument associated with the loyalty account. The available points for advance may also change depending on how quickly a previous advance is replenished, or the available advance points may increase as each previously advanced point is replenished. Practitioners will appreciate that the calculation of loyalty points available for advance may be based on any number of characteristics and variables.

Thus, a loyalty point transaction may include a participant desiring to apply loyalty points to facilitate a particular transaction over a computerized network such as the interne: (1) uses his or her charge card number to make an online purchase, (2) associates the charge card account with a loyalty account; and (3) invokes a process to apply a currency value credit (corresponding to a defined amount of loyalty points) to the participant's designated charge card account. This currency value credit may offset all or part of a corresponding purchase. Therefore, loyalty points are not used to make the purchase, but may be used to offset at least part of a corresponding charge. The integration of the loyalty program and existing transaction (e.g., charge card) account processing systems is undetectable to the merchant in that the merchant may be unaware that the customer is using loyalty points to offset at least part of the charge. Additional embodiments relate to the crediting of a variety of different accounts to facilitate particular transactions. For more information regarding loyalty points and loyalty point advance features, see U.S. application Ser. No. 11/548,203, entitled “System And Method For Issuing And Using A Loyalty Point Advance” and filed on Oct. 10, 2006 which hereby incorporated by reference in its entirety.

In one embodiment, a positive behavior reward for an incentive is associated with a loyalty point advance or a loyalty point cash conversion. The system receives a request from a consumer to exchange loyalty points for a purchase of an item. TAMS 160 analyzes the request and/or consumer information associated with the consumer to identify a desired consumer behavior. For instance, based upon a recent payment for a transaction account the consumer may have satisfied a desired consumer behavior associated with an incentive and the incentive may have an incentive reward that involves advancing loyalty points. The system determines an incentive associated with the desired consumer behavior and determines that a desired behavior attribute used to determine that the desired consumer behavior is satisfied is present in the consumer information. The system issues a loyalty point advance to the loyalty account of the consumer to facilitate the purchase and determines a positive behavior reward associated with the incentive and the loyalty point advance. In an embodiment, the reward associated with an incentive may be at least partially used to determine the amount of the advanced loyalty points available to the consumer. In one embodiment a desired consumer behavior is associated with accumulating loyalty points, depleting the loyalty point account, closing the loyalty account, closing a second loyalty account, transferring loyalty points from a second loyalty account, or redeeming loyalty points.

In one embodiment, the system may determine a time period during which the consumer may earn loyalty points to offset the loyalty point advance and a positive behavior reward associated with an incentive may involve offsetting at least a portion of the loyalty point advance in response to the determining the desired behavior attribute is satisfied. In one embodiment, the system charges a transaction account associated with the consumer for the amount of the purchase minus the cash value associated with the loyalty point advance. However, in response to determining the desired behavior for an incentive is satisfied, the system may reward the consumer by crediting the transaction account for the cash value associated with the loyalty point advance.

In one embodiment, TAMS 160 enables incentivizing positive behavior of a group and/or rewarding an entity for the positive behavior of a group related to the entity. For example, TAMS 160 rewards employees of a company with a lower minimum payment (i.e., the reward) on individual employee transaction accounts when the company either spends a certain amount using the company transaction account or when the company makes early payments for several consecutive months for the transaction account (i.e., the positive behavior). In one embodiment, an incentive is designed to reward a group for the positive behavior of its members. For example, an industry association receives rebates (i.e., the reward) for purchases made at a particular merchant based upon the members of the association achieving a cumulative spend at the merchant (i.e., the positive behavior).

In one embodiment, TAMS 160 obtain group information associated with a group, wherein the group is associated with an entity that is associated with a transaction account of the entity. For example, the group may be the employees of a company (i.e., the entity). TAMS 160 determines, based at least partially upon the group information, a positive behavior exhibited by the group. For example, the group information may indicate that more than a certain percentage of the employees have opened a personal transaction account. TAMS 160 identifies that the positive behavior is associated with an incentive and that the group is eligible to receive the incentive. For example, the company is eligible to receive the incentive based upon its transaction account type (e.g., corporate gold card). TAMS 160 produces output based upon the incentive to offer the incentive to the group. For example, the company receives a notice on their next bill that they are eligible to receive a lower APR on their transaction account due to the positive behavior associated with the company's employees opening individual transaction accounts.

In one embodiment, TAMS 160 enables detailed tracking of an incentive offer (or “solicitation”) and a response to the incentive offer. This offer and response process may be referred to as a solicitation and response lifecycle. Detailed information related to customer payment habits is of particular interest to an organization's financial operation because the information is often used to better forecast cash flows, to modify billing procedures and to increase rapid payment of bills. Due to the importance of cash in running a business, it is usually in a company's best interest to collect outstanding receivables as quickly as possible. Decreasing the average collection period is often desirable because this means that it does not take a company very long to turn its receivables into cash.

TAMS 160 provides a tangible, integrated, end-to-end customer solicitation and response lifecycle tracking mechanism. With the ability to track and analyze detailed data regarding a consumer's response to a solicitation (e.g., mailing a payment for a bill), incentives are implemented that reward positive behavior that is measured based upon the tracking data. When an organization generates a solicitation to a customer and also provides a way to respond to the solicitation, the system generates tracking data for both the solicitation and the response. The two sets of tracking data are linked such that tracking information collected for the solicitation is linked to tracking information for the response. Indicators are generated that encode the tracking data and the indicators are attached to the outgoing solicitation and the incoming response. Service providers (e.g., the U.S. Postal Service (“USPS”)) detect the indicator and store additional information regarding the time, place and status of the detected parcel. A data transfer or data sharing method provides access to the service provider data and the data is matched using various methods. A detailed audit trail of each event in the correspondence and response lifecycle is constructed. Various statistics regarding the lifecycle, and specifically the response habits of customers, is also formulated. Systems and detailed processes for tracking a solicitation and response lifecycle are disclosed in U.S. application Ser. No. 12/044,781, entitled “Solicitation-Response Lifecycle Tracking And Management” and filed on Mar. 7, 2008; U.S. application Ser. No. 12/427,225, entitled “Lifecycle Tracking And Management Using RF” and filed on Apr. 21, 2009; and U.S. application Ser. No. 12/437,491, entitled “Marketing Communication Tracking” and filed on May 7, 2009, all of which are hereby incorporated by reference in their entirety.

In one embodiment, the solicitation is a customer bill that comprises either and the response is the remittance of the bill. In such an embodiment, the invention includes: i) receiving, first distribution tracking data from a service provider, where the first distribution tracking data is based at least partially upon detection of a first tracking indicator which is associated with a first tracking identifier and where the first tracking indicator is configured to be detected and the first tracking identifier is associated with a consumer solicitation; ii) matching a first tracking dataset with the first distribution tracking data to create matched tracking data; iii) receiving at least a portion of first response tracking data, where the first response tracking data is based on detection of a first response tracking indicator and includes the first tracking identifier along with additional information, and where the first tracking identifier is encoded in the first response tracking indicator on a consumer response such that the response tracking indicator is configured to be detected, and where a portion of the consumer solicitation comprises the consumer response; iii) updating the matched tracking data by matching the first tracking dataset with the first response tracking data; iv) analyzing the first distribution tracking data, the first response tracking data and/or the matched tracking data to determine an incentive; v) associating the incentive with the matched tracking data; and vi) producing output based at least partially upon at least one of the matched tracking data and the incentive. For example, in step iv) above, the matched tracking data may indicate that the consumer mailed a payment for a bill within eight days of receiving the bill. Based upon this tracking data, TAMS 160 may determine that the consumer be offered an incentive that rewards the consumer for the positive behavior of mailing a payment for the bill within two days of receiving the bill.

In an embodiment, tracking and management data for a solicitation and response lifecycle is enabled using radio frequency (RF) identifiers (RFIDs). The system generates and links tracking data using, in some cases, two indicators. The second indicator is useful to track a parcel while it is in the manufacturing (e.g. billing) process prior to shipping. The RF signal of the indicator is useful in receiving tracking information that cannot otherwise be optically scanned (e.g., scanning a barcode) because of the way the parcels are stacked together.

In an embodiment, incentives are based upon limited use identifier accounts, usage, transactions, etc. In one embodiment, a limited use identifier (LUI) is a transaction account identifier. Moreover, pursuant to some embodiments, LUIs may be associated with a “pre-authorization record” (or, put another way, account identifiers may be “pre-authorized”). The term “pre-authorized” or “pre-authorization record” includes data associated with an account identifier which specifies the conditions in which a transaction associated with the account will be authorized. Such a condition may be referred to as “use restriction.” An LUI may be associated with a reward or with a positive behavior of an incentive. For example, an incentive may be intended to influence the payment amount that is remitted for a transaction account such that if a payment is received for a transaction account that is certain percentage above the minimum payment, an award may include an LUI that can be used for a limited amount of time to purchase items from a number of merchants. In this way, LUI's are useful to the issuer as rewards since the use restriction is an efficient and effective way to implement restrictions on the time, amount and type of reward. In an embodiment, an LUI may also be associated with a positive behavior. For example, an issuer may issue a large number of LUI's as part of a promotion and an APR associated with the LUI may be lower than the issuer is now willing to support. Thus, the issuer may design a promotion with the objective of eliminating these particular LUI's. Thus, the incentive may award loyalty points to a loyalty account for the positive behavior of paying off the balance associated with an LUI and closing the LUI.

In an embodiment, an LUI includes individual accounts that are associated with a particular master account. In one embodiment, a plurality (or a “pool”) of these LUI's may be associated with a master account and the LUI's are used by the purchasing entity to purchase goods or services. In an embodiment, a transaction facilitator acts as the intermediary between a consumer associated with the limited use identifier and the merchant. For example, the intermediary may allocate LUI's of a LUI pool, implement or modify use restrictions associated with the LUI' s etc. Furthermore, limited use identifiers may involve a partial shipment and/or limited use identifiers that may involve refreshing the preauthorization information. For more information regarding limited use identifiers, partial shipments, and refreshable limited use identifiers please see U.S. patent application Ser. No. 12/355,576, filed on Jan. 16, 2009 and entitled “Authorization Refresh System And Method”; U.S. application Ser. No. 10/724,940, entitled “Method And System For Completing Transactions Involving Partial Shipments” and filed on Dec. 1, 2003; U.S. application Ser. No. 10/391,689, entitled “Method And Apparatus For Facilitating A Transaction” and filed on Mar. 19, 2003.

In an embodiment, TAMS 160 creates, manages, evaluates positive behavior and issues rewards for incentives associated with LUI's by: i) receiving a first authorization request including transaction information identifying a transaction, the first authorization request comprising merchant information, an account identifier corresponding to a transaction account, and a transaction amount; ii) identifying a first pre-authorization record associated with the account identifier; iii) determining that the transaction amount complies with authorization criteria associated with the first pre-authorization record; iv) analyzing the transaction information to determine a positive behavior attribute; v) associating the positive behavior attribute with an incentive; vi) updating the pre-authorization record based upon the incentive; and transmitting an authorization message to the merchant. For example, in step iv) above, TAMs 160 may identify an incentive is designed to promote transactions with a certain (e.g. pre-determined set) of merchants. Thus, when the transaction information indicates a purchase from such a merchant (positive behavior) TAMS 160 updates the pre-authorization record to indicate that the APR for the LUI should be lowered.

In an embodiment, TAMS 160 determines that a refresh of an LUI should occur based upon a pre-authorization record, an incentive, a positive behavior attribute or an award associated with an incentive; and, in response to determining that refresh should occur, TAMS 160 refreshes the authorization criteria by creating a second pre-authorization record (e.g., a second pre-authorization record with a higher pre-approved transaction limit).

In an embodiment, TAMS 160 determines based on transaction information, that the transaction involves a partial shipment and calculates a new pre-authorized amount for the LUI based at least partially upon a predetermined rule comprising reducing a previous pre-authorized amount by at least a portion of the transaction amount. TAMS 160 may further determine that a incentive associated with the LUI is predicated on the positive behavior of accepting a partial shipment. This, in response to the partial shipment (i.e., the positive behavior) TAMS 160 may modify the payment terms associated with the LUI to lower the minimum payment (i.e., the reward) due on the next bill.

The unique combinations of features of the present invention, as described above, have been shown in research to attract new small business consumers to a transaction account company. A transaction account company can also expect incremental charge volume from additional usage. Merchants can better manage Days Sales Outstanding (DSO) as well as collection risk by encouraging consumers to put more purchases on the transaction account of the present invention. Additionally, for those merchants who were previously offering discount terms for payment on check or cash, they can forego the terms by accepting the account of the present invention instead.

Consumers are better able to manage variable cash flow conditions by utilizing the two features of the invention (i.e., early and deferred payments). For example, the Early Payment Discount provides a discount off of the current bill that can be invested back into the consumer's business. The Defer Payment feature allows the consumer to defer payment of large purchases, during a slow month or as a financial management strategy, for an additional billing cycle (total grace is up to 90 days on new purchases). This invention also permits a transaction account company to offer a new product and service that will ultimately attract new transaction accounts and drive increased charge volume.

Further, by providing incentives as disclosed in various aspects of the present invention, transaction account issuing companies may encourage more consumers to shift from ordinary payment behavior to desirable payment behavior. Desirable payment behavior may be, for example, one or more of paying early, paying more than the minimum amount due, paying through an automatic payment channel, and /or the like. Also, the transaction account issuing companies may be able to differentiate between consumers on the basis of the default risk they pose, where a consumer exhibiting desirable payment behavior is less likely to default than a consumer exhibiting ordinary payment behavior. With the help of this differentiation, the transaction account issuing companies may offer better incentives to low risk consumers, thereby providing additional value to these consumers and creating stronger consumer loyalty. In addition, the transaction account issuing companies would be able to attract low risk profile consumers. Moreover, by monitoring the payment behavior of consumers using various aspects of the present invention, the transaction account issuing companies may identify potential risk associated with consumers at an earlier stage. For example, when a consumer demonstrating desirable payment behavior shifts to ordinary payment behavior for a certain period, it may prompt the transaction account issuing company to increase potential risk associated with that consumer and may allow the transaction account issuing company to take corrective action.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to ‘at least one of A, B, or C’ is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. All structural, chemical, and functional equivalents to the elements of the above-described exemplary embodiments that are known to those of ordinary skill in the art are expressly incorporated herein by reference and are intended to be encompassed by the present claims. Further, a list of elements does not include only those elements but may include other elements not expressly listed or inherent to such process, method, article, or apparatus.

We claim:

1. A method comprising:
obtaining, by a computer, consumer information associated with a consumer, wherein the consumer is associated with a first transaction account;
determining, by the computer and based at least partially upon the consumer information, a desired positive behavior of the consumer;
determining, by the computer, a first incentive associated with the desired positive behavior;
determining, by the computer and based at least partially upon the desired positive behavior, that the consumer is eligible to receive the first incentive; and
producing, by the computer, output based at least partially upon the first incentive in order to offer the consumer the first incentive.

2. The method of claim 1, wherein the first incentive is associated with at least one of the first transaction account or the consumer.

3. The method of claim 1, further comprising determining a second incentive associated with the desired positive behavior.

4. The method of claim 1, further comprising determining, based at least partially upon the consumer information, a first positive behavior of the consumer.

5. The method of claim 4, wherein the determining that the consumer is eligible to receive the first incentive is at least partially based upon the desired positive behavior and the first positive behavior.

6. The method of claim 4, further comprising determining, based at least partially on the first positive behavior, that the consumer is eligible to receive a second incentive.

7. The method of claim 6, wherein the output is based at least partially upon the second incentive.

8. The method of claim 1, wherein the consumer information comprises at least one of consumer demographic data, consumer profile data, first transaction account history, a second transaction account history, a first transaction account type, a payment received for the first transaction account or consumer payment history.

9. The method of claim 1, wherein the consumer information is obtained from at least one of a billing system, an accounting system, a transaction account authorization system, a collections system, an account management system, a customer relationship management system, a credit bureau, a third-party, a service provider, or a merchant.

10. The method of claim 1, wherein the desired positive behavior comprises at least one of paying a bill earlier than a due date, paying the bill on-time or paying the bill within a predefined timeframe.

11. The method of claim 10, wherein the bill is associated with a transaction account of the consumer.

12. The method of claim 1, wherein the desired positive behavior comprises at least one of paying an amount for a bill that is more than a minimum amount due for the bill, paying an amount for the bill more than a percentage of a total outstanding balance indicated on the bill, paying a total amount over several billing cycles, paying the bill through an automatic payment channel, or renewing a membership within a predetermined timeframe for renewal, renewing an account within a predetermined timeframe for renewal, or renewing a subscription within a predetermined timeframe for renewal.

13. The method of claim 1, wherein the first transaction account is at least one of a credit account, a line of credit, or a charge account.

14. The method of claim 1, wherein the first incentive is associated with a first reward and the first reward comprises at least one of a lower Annual Percentage Rate (APR) or an achievement credit toward a lower APR.

15. The method of claim 1, wherein the first incentive is associated with a first reward and the first reward comprises at least one of a discount on finance charges, a rebate on finance charges, a discount on fees, or a rebate on fees.

16. The method of claim 1, wherein the first incentive is associated with a first reward and the first reward comprises at least one of a cash bonus, a cash-back amount, loyalty points, an increased credit line, an increased spend line, a statement credit, or a gift voucher.

17. The method of claim 1, wherein the first incentive is associated with a first reward and the first reward comprises adjusting an incentive of a second account comprising at least one of a lower APR, a cash bonus, a cash-back amount, an achievement credit, loyalty points, an accumulation of a balance associated with a second incentive, increased credit line, increased spend line, statement credit, or gift voucher.

18. The method of claim 1, wherein the first incentive is associated with a first reward and the first reward comprises at least one of waiving an annual fee associated with a consumer account, upgrading status of account consumer account, upgrading status of a second consumer account, upgrading the status of a third-party account, providing access to a club, providing access to a website, providing access to discounted products, upgrading a consumer account to a VIP status, providing a preferred bidding status to an item in an auction, providing a preferred access to an item in an auction, providing a loaded smart card, or paying the consumer an interest amount based at least partially upon the early payment amount.

19. The method of claim 1, wherein the producing output comprises calculating a bill for the first transaction account based at least partially upon a first reward associated with the first incentive and providing the bill to the consumer.

20. A tangible computer-readable medium having computer-executable instructions stored thereon that, if executed by a computer, cause the computer to perform a method comprising:
obtaining, by the computer, consumer information associated with a consumer, wherein the consumer is associated with a first transaction account;
determining, by the computer and based at least partially upon the consumer information, a first positive behavior of the consumer;
determining, by the computer, a first incentive associated with the first positive behavior;
determining, by the computer and based at least partially upon the first positive behavior, that the consumer is eligible to receive the first incentive; and
producing, by the computer, output based at least partially upon the first incentive in order to offer the consumer the first incentive.

21. A system comprising:
a network interface communicating with a memory;
the memory communicating with a processor; and
the processor, when executing a computer program, is configured to:
obtain consumer information associated with a consumer, wherein the consumer is associated with a transaction account;
determine and based at least partially upon the consumer information, a first positive behavior of the consumer;
determine a first incentive associated with the first positive behavior;
determine based at least partially upon the first positive behavior, that the consumer is eligible to receive the first incentive; and
produce output based at least partially upon the first incentive in order to offer the consumer the first incentive.
